(19) United States
(12) Patent Application Publication
(10) Pub. No.: US 2010/0153432 A1
(43) Pub. Date: Jun. 17, 2010

(54) OBJECT BASED MODELING FOR SOFTWARE APPLICATION QUERY GENERATION

(75) Inventors: Wolfgang Pfeifer, Kerzenheim (DE); Torsten Bachmann, St. Leon-Rot (DE); Dirk Baumgaertel, Hockenheim (DE); Peter Haerle, Walldorf (DE); Joerg Latza, St. Leon-Rot (DE); Andreas Sandner, Altlussheim (DE); Werner Sinzig, Nussloch (DE); Ivo Vollrath, Waghausel (DE)

Correspondence Address: FISH & RICHARDSON, P.C., PO BOX 1022, MINNEAPOLIS, MN, 55440-1022, US

(73) Assignee: SAP AG

(21) Appl. No.: 12/333,231

(22) Filed: Dec. 11, 2008

(51) Int. Cl. G06F 17/30

(52) U.S. Cl. 707/769; 707/E17.055; 707/E17.014

(57) ABSTRACT

This disclosure relates to computer implemented methods, systems, and software for querying data associated with a service-oriented enterprise software application. A query request is received, for data associated with a service-oriented enterprise software application. A business information view object can be identified based on the query request. Using a query embodied in the business information view object, business objects can be queried that are decoupled from the enterprise software application. In another instance, a business object associated with a service-oriented enterprise software application can be identified and metadata extracted, relating to the identified business object. Business information view objects can be automatically generated based on the business object and the extracted metadata.

### TECHNICAL FIELD

This disclosure relates to computer systems and methods and, more particularly, to methods, systems, and software for querying and reporting within an object-based, or service-oriented, software environment.

### BACKGROUND

Enterprise software systems are generally large and complex. Such systems can require many different components, distributed across many different hardware platforms, possibly in several different geographical locations. In order to design, configure, update or implement an enterprise software system, one is generally required to understand details of the system at varying levels, depending on his role in designing, managing or implementing the system. For example, a systems administrator may need a high-level technical understanding of how various software modules are installed on physical hardware, such as a server device or a network, and how those software modules interact with other software modules in the system. A person responsible for configuring the software may utilize a high-level functional understanding of the operations that each functional component provides. An application designer may utilize a low-level technical understanding of the various software interfaces that portions of the application require or implement. And an application developer may utilize a detailed understanding of the interfaces and functionality he is implementing in relation to the remainder of the system. But the flow of a business process within an application today is typically hidden from a user. In some cases, it is possible to manually create a textual or graphical documentation of this process flow. However, this documentation is typically not detailed enough and can become quickly outdated since its consistency with the actual application software is not (initially) verified or maintained automatically.

Within a development environment, an application can be developed using modeling systems. In general, these models can specify the types of development objects or components that can be used to build applications, as well as the relationships that can be used to connect those components. In an object-oriented architecture, for example, a defined application can include a combination of various data objects and resources (i.e., development objects). In that example, relationships among the development objects can include a relationship indicating that one data object inherits characteristics from another data object. Another example architecture is the model-view-controller (MVC) architecture. Applications built using the MVC architecture typically include three different types of components—models, which store data such as application data; views, which display information from one or more models; and controllers, which can relate views to models, for example, by receiving events (e.g., events raised by user interaction with one or more views) and invoking corresponding changes in one or more models. When changes occur in a model, the model can update its views. Data binding can be used for data transport between a view and its associated model or controller. For example, a table view (or a table including cells that are organized in rows and columns) can be bound to a corresponding table in a model or controller. Such a binding indicates that the table is to serve as the data source for the table view and, consequently, that the table view is to display data from the table. Continuing with this example, the table view can be replaced by another view, such as a graph view. If the graph view is bound to the same table, the graph view can display the data from the table without requiring any changes to the model or controller. In the MVC architecture, development objects can include models, views, controllers, and components that make up the models, views, and controllers. For example, application data in a model can be an example of a component that is a development object.

Dedicated reporting and analytics modularity can also be provided with enterprise software deployments. While certain flows, functionality, and infrastructure may be hidden from enterprise customers to protect enterprise system integrity, in addition to modeling, customers can be provided with customized reporting and querying functionality in connection with the enterprise software deployment. To protect functionality and infrastructure of the system, specialized query data structures can be developed drawing from data structures and data relationships of the system and delivered applications, that can be used in connection with the reporting module to process queries relating to the data structures upon which the specialized query data structures are based. Where specialized query data structures do not yet exist for an underlying data structure, the specialized query data structures can be “staged” by developers, in essence converting the underlying data structure and its relational attributes within the system into a corresponding query data structure capable of being processed and queried by the reporting module.

### SUMMARY

This disclosure relates to computer implemented methods, systems, and software for querying data associated with a service-oriented enterprise software application. A query request is received, for data associated with a service-oriented enterprise software application. A business information view object can be identified based on the query request. Using a query embodied in the business information view object, business objects can be queried that are decoupled from the enterprise software application. In another instance, a business object associated with a service-oriented enterprise software application can be identified and metadata extracted, relating to the identified business object. Business information view objects can be automatically generated based on the business object and the extracted metadata.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example object-based, or service-oriented, software environment in accordance with one embodiment of the present disclosure;

FIG. 2A depicts an example metamodel of a business object for use in a system such as that described in FIG. 1;

FIG. 2B depicts an example graphical representation of one of the business objects;

FIG. 2C illustrates an example metamodel of a Business Information View (BIVi) object for use in a system such as that described in FIG. 1;

FIG. 3A depicts an example modeling environment in accordance with one embodiment of FIG. 1;

FIG. 3B depicts a simplified process for mapping a model representation to a runtime representation using the example modeling environment of FIG. 1 or some other modeling environment;

FIG. 3C illustrates example modeling phases using the example modeling environment of FIG. 1 or some other modeling environment;

FIG. 4 illustrates a flowchart of an example technique for generating a query definition in accordance with one embodiment of the present disclosure; and

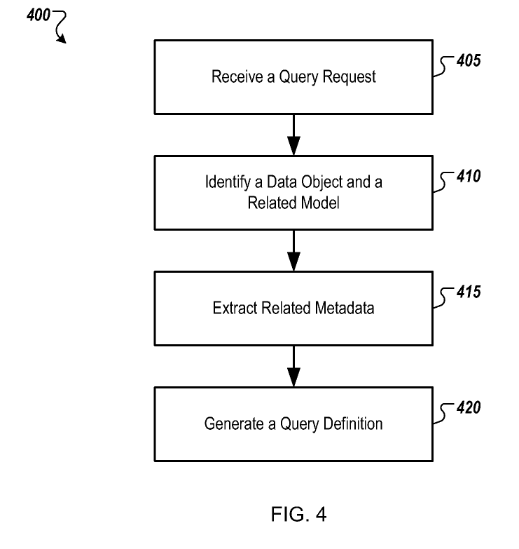

FIG. 5 illustrates a schematic representation of an example query generation.

### DETAILED DESCRIPTION

At a high level, this disclosure involves applications modeled on a service-oriented architecture (SOA). In some cases, these applications may utilize, implement, or enable analytics that provide information workers and business analysts with comprehensive views they need to take actions guided by strategy that are appropriate, timely, and in concert with colleagues and the rest of the value network. In other words, facts-based understanding of customers and prospects—as well as suppliers, partners, employees, and broader economic indicators—can be used in both strategic and operational processes. In some cases, these analytics deliver insights across the extended value network, spanning multiple business functions, departments, and even organizations. Plus, the analytic functions are usually designed for information workers, so they can be easy to use, modify, and extend.

More specifically, this disclosure generally describes an example technique for automatically generating query definitions for software applications employing business data objects, often for use in such analytics. These query definitions are capable of being processed directly by reporting applications from the underlying business objects and other architecture elements without the need for separate staging and development of specialized data query objects. In one configuration, this is accomplished through a Business Information View (BIVi) object 135 that embodies the metadata of underlying objects and modeling entities, as well as the query definition. This typically allows the reporting functionality of the system to enjoy, among other benefits, increased extensibility and customizability by the end user or customer. To allow a user to create queries on top of the underlying modeling entities and business objects, the BIVi modeling layer can include or reference information such as business semantics, underlying business object and data object structure, associations between objects, and cardinality. As such, the disclosed software functionality and techniques include identifying data structures, such as business objects, models, and related metadata, to which a desired query relates. Identified business objects, together with related metadata, can include attributes that help define the structure and interrelationships of data that is to be the subject of the query. An improved query definition generation technique takes advantage of the internal metadata of data structures and applications to automatically generate a query definition capable of being used by reporting and analytics applications to process data and complete the query using the generated query definition. By removing the staging step, development resources can also be utilized more efficiently, diverted toward other system goals, rather than the development of shadow data structures for implementing query requests.

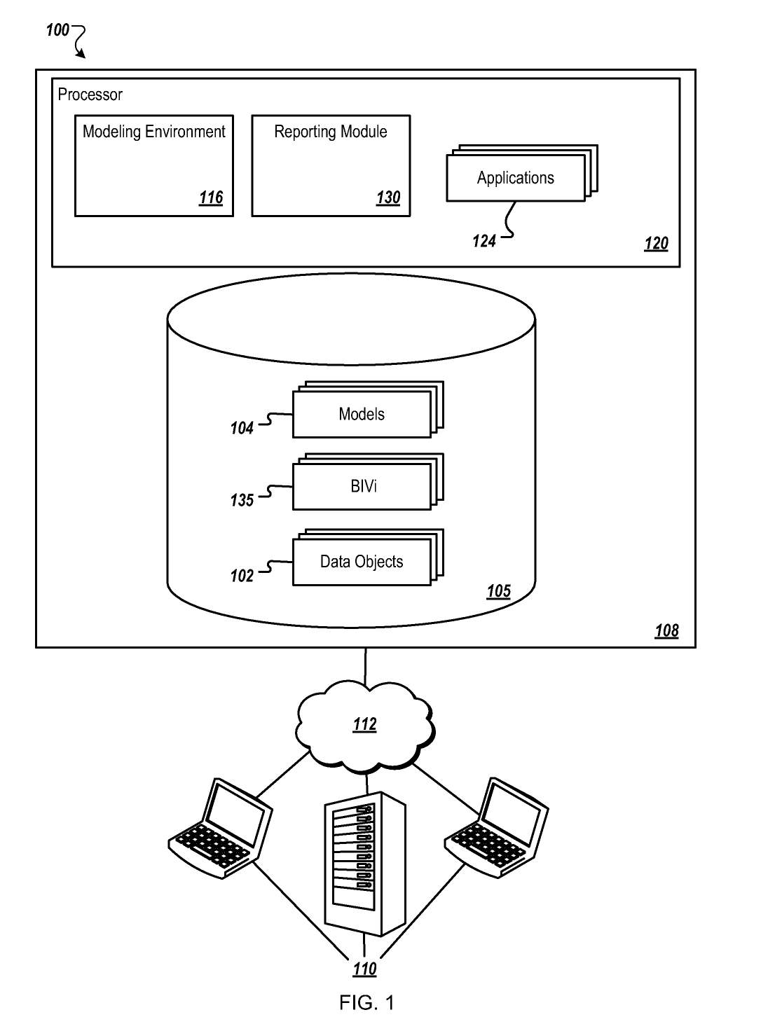

FIG. 1 illustrates an example enterprise software environment 100. Environment 100 is typically a distributed client/server system that spans one or more networks such as 112. In some situations, rather than being delivered as packaged software, portions of environment 100 may represent a hosted solution, often for an enterprise or other small business, that may scale cost-effectively and help drive faster adoption. In this case, portions of the hosted solution may be developed by a first entity, while other components may be developed by a second entity. Moreover, the processes or activities of the hosted solution may be distributed amongst these entities and their respective components. In other embodiments, environment 100 may be in a dedicated enterprise environment—across a local area network or subnet—or any other suitable environment without departing from the scope of this disclosure.

Turning to the illustrated embodiment, environment 100 includes, or is communicably coupled, with server 108 and one or more clients 110, at least some of which communicate across network 112. Server 108 comprises an electronic computing device operable to receive, transmit, process and store data associated with environment 100. For example, server 108 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 1 provides merely one example of computers that may be used with the disclosure. Each computer is generally intended to encompass any suitable processing device. For example, although FIG. 1 illustrates one server 108 that may be used with the disclosure, environment 100 can be implemented using computers other than servers, as well as a server pool. Indeed, server 108 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Server 108 may be adapted to execute any operating system including Linux, UNIX, Windows Server, or any other suitable operating system. According to one embodiment, server 108 may also include or be communicably coupled with a web server and/or a mail server.

Illustrated server 108 includes example processor 120. Although FIG. 1 illustrates a single processor 120 in server 108, two or more processors may be used according to particular needs, desires, or particular embodiments of environment 100. Each processor 120 may be a central processing unit (CPU), a blade, an application specific integrated circuit (ASIC), or a field-programmable gate array (FPGA). The processor 120 may execute instructions and manipulate data to perform the operations of server 108, often using software. Regardless of the particular implementation, “software” may include computer-readable instructions, firmware, wired or programmed hardware, or any combination thereof on tangible medium as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

In the illustrated embodiment, processor 120 executes a model-driven development tool (or environment) 116 and modeled business applications 124. At a high level, the modeling environment 116 and applications 124 are operable to receive and/or process requests from developers and/or users and present at least a subset of the results to the particular user via an interface. Put differently, different instances of the modeling tool may be executing for developers and for end users, perhaps using client 110.

The client 110 is any computing device operable to process data for an end user. For example it may connect or communicate with the server or the network using a wireless connection, or it may be a stand alone device. At a high level, each client includes at least the GUI and, in some cases, an agent and comprises an electronic computing device operable to receive, transmit, process and store any appropriate data associated with the backup system. It will be understood that there may be any number of clients communicably coupled to the server. For example, the clients can include one local client and three external clients to the illustrated portion of the network. Further, “the client,” “customer,” and “user” may be used interchangeably as appropriate without departing from the scope of this disclosure. For example, the investor may also be a user of the client. Moreover, for ease of illustration, each client is described in terms of being used by one user. But this disclosure contemplates that many users may use one computer or that one user may use multiple computers. As used in this disclosure, the client is intended to encompass a personal computer, touch screen terminal, workstation, network computer, kiosk, wireless data port, smart phone, personal data assistant (PDA), one or more processors within these or other devices, or any other suitable processing device. For example, the client may be a laptop that includes an input device, such as a keypad, touch screen, mouse, or other device that can accept information, and an output device that conveys information associated with the operation of the server or the clients, including digital data, visual information, or the GUI. Both the input device and output device may include fixed or removable storage media such as a magnetic computer disk, CD-ROM, or other suitable media to both receive input from and provide output to users of the clients through the display, namely the GUI.

The GUI comprises a graphical user interface operable to, for example, allow the user of the client to interface with at least a portion of the platform for any suitable purpose, such as creating, preparing, requesting, or analyzing analytics and associated queries and reports. Generally, the GUI provides the particular user with an efficient and user-friendly presentation of business data provided by or communicated within the system. The GUI may comprise a plurality of customizable frames or views having interactive fields, pull-down lists, and buttons operated by the user. The GUI is often configurable, supports a combination of tables and graphs (bar, line, pie, status dials, etc.), and is able to build real-time portals, where tabs are delineated by key characteristics (e.g. site or micro-site). The GUI is further operable to generate or request historical reports. Generally, historical reports provide critical information on what has happened including static or canned reports that require no input from the user and dynamic reports that quickly gather run-time information to generate the report. Therefore, the GUI contemplates any suitable graphical user interface, such as a combination of a generic web browser, intelligent engine, and command line interface (CLI) that processes information in the platform and efficiently presents the results to the user visually. The server can accept data from the client via the web browser (e.g., Microsoft Internet Explorer or Mozilla Firefox) and return the appropriate HTML or XML responses to the underlying engine using the network.

The network 112 facilitates wireless or wireline communication between the server and any other local or remote computer, such as the clients. The network may be all or a portion of an enterprise or secured network. In another example, the network may be a virtual private network (VPN) merely between the server and the client across wireline or wireless link. Such an example wireless link may be via 802.11a, 802.11b, 802.11g, 802.11n, 802.20, WiMax, and many others. While described as a single or continuous network, the network may be logically divided into various sub-nets or virtual networks without departing from the scope of this disclosure, so long as at least portion of the network may facilitate communications between the server and at least one client. In other words, the network encompasses any internal or external network, networks, sub-network, or combination thereof operable to facilitate communications between various computing components in the system. The network may communicate, for example, Internet Protocol (IP) packets, Frame Relay frames, Asynchronous Transfer Mode (ATM) cells, voice, video, data, and other suitable information between network addresses. The network may include one or more local area networks (LANs), radio access networks (RANs), metropolitan area networks (MANs), wide area networks (WANs), all or a portion of the global computer network known as the Internet, and/or any other communication platform or systems at one or more locations. In certain embodiments the network may be a secure network associated with the enterprise and certain local or remote clients.

Returning to the example modeling environment 116, the environment 116 may provide a personalized, secure interface that helps unify enterprise applications, information, and processes into a coherent, role-based portal experience. Further, the modeling environment may allow the developer to access and share information and applications in a collaborative environment. In this way, virtual collaboration rooms allow developers to work together efficiently, regardless of where they are located, and may enable powerful and immediate communication that crosses organizational boundaries, while enforcing security requirements. Indeed, the modeling environment 116 may provide a shared set of services for finding, organizing, and accessing unstructured content stored in third-party repositories, and content management systems across various networks 112. Classification tools may automate the organization of information, while subject-matter experts and content managers can publish information to distinct user audiences. Regardless of the particular implementation or architecture, this modeling environment 116 may allow the developer to easily model various elements using this model-driven approach. As described in more detail later, the model is deployed, and environment 100 may translate the model into the required code or data structures for at least one application 124 or web service. This deployed business application 124 may then be modified or enhanced, as appropriate, using the modeling environment 116.

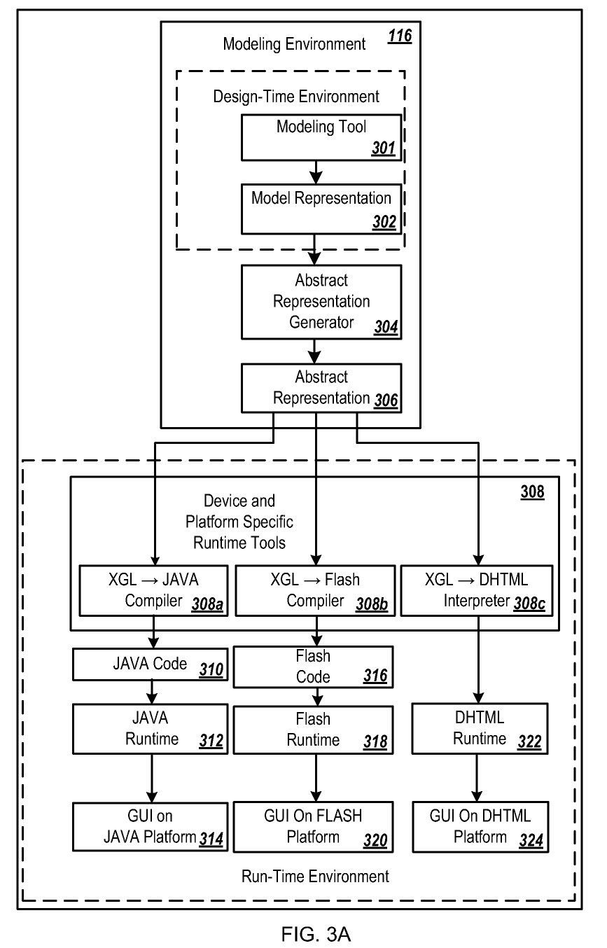

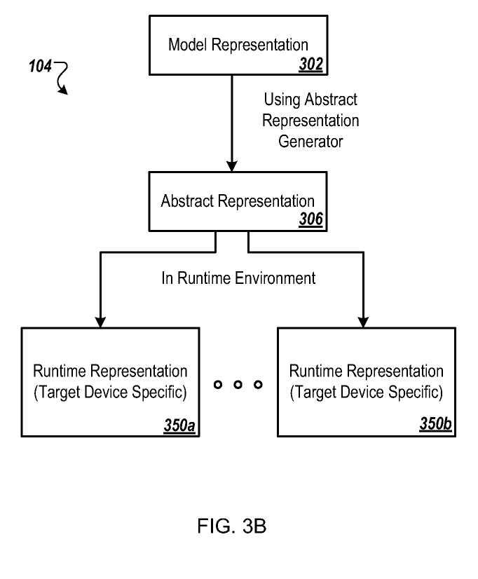

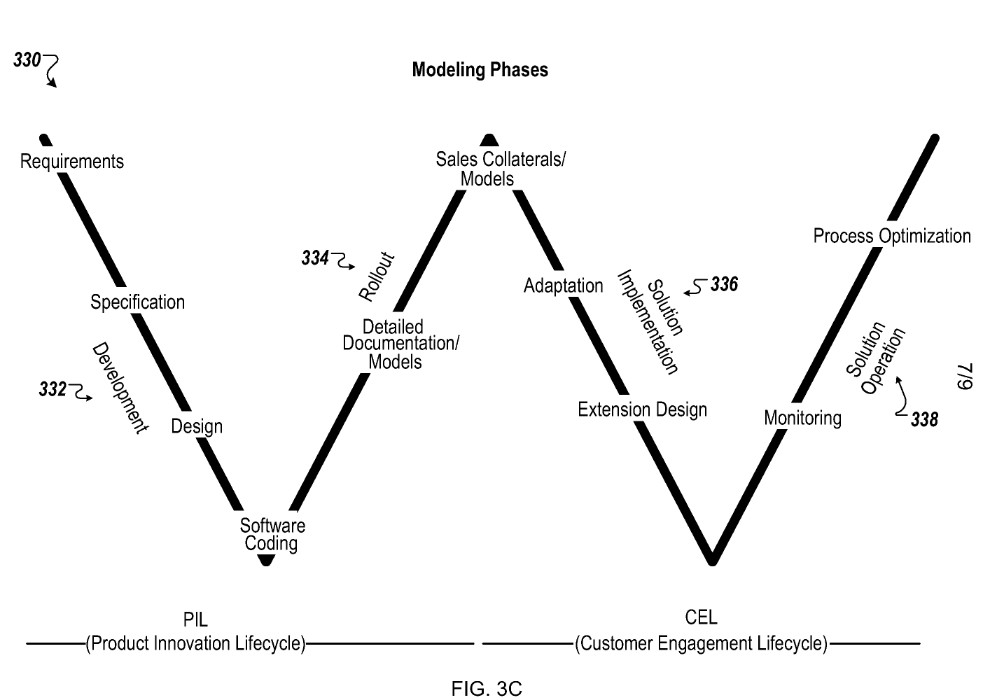

FIG. 3A depicts a more detailed example modeling environment 116, in accordance with one embodiment of the present disclosure. Such a modeling environment 116 may implement techniques for decoupling models created during design-time from the runtime environment. In other words, model representations for GUIs created in a design-time environment are decoupled from the runtime environment in which the GUIs are executed. Often, in these environments, a declarative and executable representation for GUIs for applications is provided that is independent of any particular runtime platform, GUI framework, device, or programming language.

In certain embodiments, the modeling environment 116 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and, therefore, can unambiguously encapsulate execution semantics for the GUI described by a model representation. In short, models of different types can be transformed to XGL representations.

The XGL representation may be used for generating representations of various different GUIs and supporting various GUI features, including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 3A, modeling tool 301 may be used by a GUI designer or business analyst during the application design phase to create a model representation 302 for a GUI application. It will be understood that modeling environment 116 may include or be compatible with various different modeling tools 301 used to generate model representation 302. This model representation 302 may be a machine-readable representation of an application or a domain specific model. Model representation 302 generally encapsulates various design parameters related to the GUI such as GUI components, dependencies between the GUI components, inputs and outputs, and the like. Put another way, model representation 302 provides a form in which the one or more models can be persisted and transported, and possibly handled by various tools such as code generators, runtime interpreters, analysis and validation tools, merge tools, and the like. In one embodiment, model representation 302 maybe a collection of XML documents with a well-formed syntax.

Illustrated modeling environment 116 also includes an abstract representation generator (or XGL generator) 304 operable to generate an abstract representation (for example, XGL representation or XGL-compliant representation) 306 based upon model representation 302. Abstract representation generator 304 takes model representation 302 as input and outputs abstract representation 306 for the model representation. Model representation 302 may include multiple instances of various forms or types, depending on the tool/language used for the modeling. In certain cases, these various different model representations may each be mapped to one or more abstract representations 306. Different types of model representations may be transformed or mapped to XGL representations. For each type of model representation, mapping rules may be provided for mapping the model representation to the XGL representation. 306. Different mapping rules may be provided for mapping a model representation to an XGL representation.

This XGL representation 306 that is created from a model representation may then be used for processing in the runtime environment. For example, the XGL representation 306 may be used to generate a machine-executable runtime GUI (or some other runtime representation) that may be executed by a target device. As part of the runtime processing, the XGL representation 306 may be transformed into one or more runtime representations, which may indicate source code in a particular programming language, machine-executable code for a specific runtime environment, executable GUI, and so forth, that may be generated for specific runtime environments and devices. Since the XGL representation 306, rather than the design-time model representation, is used by the runtime environment, the design-time model representation is decoupled from the runtime environment. The XGL representation 306 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 306 generated for a model representation 302 is generally declarative and executable in that it provides a representation of the GUI of model 302 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 306 is also not GUI runtime platform-specific. The abstract representation 306 provides a self-contained, closed, and deterministic definition of all aspects of a graphical user interface that is device independent and language independent.

Abstract representation 306 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), and the GUIs generated by the devices are consistent with each other in their appearance and behavior.

Abstract generator 304 may be configured to generate abstract representation 306 for models of different types, which may be created using different modeling tools 301. It will be understood that modeling environment 116 may include some, none, or other sub-modules or components as those shown in this example illustration. In other words, modeling environment 116 encompasses the design-time environment (with or without the abstract generator or the various representations), a modeling toolkit (such as 301) linked with a developer's space, or any other appropriate software operable to decouple models created during design-time from the runtime environment. Abstract representation 306 provides an interface between the design-time environment and the runtime environment. As shown, this abstract representation 306 may then be used by runtime processing.

As part of runtime processing, modeling environment 116 may include various runtime tools 308 and may generate different types of runtime representations based upon the abstract representation 306. Examples of runtime representations include device or language-dependent (or specific) source code, runtime platform-specific machine-readable code, GUIs for a particular target device, and the like. The runtime tools 308 may include compilers, interpreters, source code generators, and other such tools that are configured to generate runtime platform-specific or target device-specific runtime representations of abstract representation 306. The runtime tool 308 may generate the runtime representation from abstract representation 306 using specific rules that map abstract representation 306 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 306 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 3A, an XGL-to-Java compiler 308a may take abstract representation 306 as input and generate Java code 310 for execution by a target device comprising a Java runtime 312. Java runtime 312 may execute Java code 310 to generate or display a GUI 314 on a Java-platform target device. As another example, an XGL-to-Flash compiler 308b may take abstract representation 306 as input and generate Flash code 316 for execution by a target device comprising a Flash runtime 318. Flash runtime 318 may execute Flash code 316 to generate or display a GUI 320 on a target device comprising a Flash platform. As another example, an XGL-to-DHTML (dynamic HTML) interpreter 308c may take abstract representation 306 as input and generate DHTML statements (instructions) on the fly which are then interpreted by a DHTML runtime 322 to generate or display a GUI 324 on a target device comprising DHTML platform.

It should be apparent that abstract representation 306 may be used to generate GUIs for Extensible Application Markup Language (XAML) or various other runtime platforms and devices. The same model representation 306 may be mapped to various runtime representations and device-specific and runtime platform-specific GUIs. In general, in the runtime environment, machine executable instructions specific to a runtime environment may be generated based upon the abstract representation 306 and executed to generate a GUI in the runtime environment. The same XGL representation may be used to generate machine executable instructions specific to different runtime environments and target devices.

According to certain embodiments, the process of mapping a model representation 302 to an abstract representation 306 and mapping an abstract representation 306 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 306 rather than model representation 302 for runtime processing, the model representation 302 that is created during design-time is decoupled from the runtime environment. Abstract representation 306 thus provides an interface between the modeling environment and the runtime environment. As a result, changes may be made to the design time environment, including changes to model representation 302 or changes that affect model representation 302, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies, such as the target device platform or programming language dependencies.

FIG. 3B depicts an example process for mapping a model representation 302 to a runtime representation using the example modeling environment 116 of FIG. 3A or some other modeling environment. Model representation 302 may comprise one or more model components 104 and associated properties that describe a modeling domain, such as interfaces, processes, and data. The abstract representation 306 is generated based upon model representation 302. Abstract representation 306 may be generated by the abstract representation generator 304. Abstract representation 306 comprises one or more abstract GUI components and properties associated with the abstract GUI components. As part of generation of abstract representation 306, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 350, including GUIs for specific runtime environment platforms, may be generated from abstract representation 306. A device-dependent runtime representation may be generated for a particular type of target device platform to be used for executing and displaying the GUI encapsulated by the abstract representation. The GUIs generated from abstract representation 306 may comprise various types of GUI elements such as buttons, windows, scrollbars, inputs boxes, etc. Rules may be provided for mapping an abstract representation to a particular runtime representation. Various mapping rules may be provided for different runtime environment platforms.

As described with respect to FIG. 3A, modeling tool 301 may be used by a GUI designer or business analyst during the application design phase to create a model representation 302 for a GUI application. In addition, modeling tool 301 may be used during other modeling phases and by other types of users to create model representations 302 for a GUI application. FIG. 3C illustrates example modeling phases 330 using the example modeling environment 116 of FIG. 3A or some other modeling environment. Modeling phases 330 may include development 332, rollout 334, solution implementation 336, and solution operation 338. In some implementations, development 332 and rollout 334 represent a product innovation lifecycle, while solution implementation 336 and solution operation 338 represent a customer engagement lifecycle. Development 332 may include, for example, determining requirements of a product or application, writing a specification for the product or application, designing the product or application, and writing software code for the product or application. Rollout 334 may continue with software coding, and also includes generating detailed documentation and/or detailed models, as well as sales collaterals and/or sales models. Solution implementation 336 may continue with generation of sales collaterals and/or models, and also includes adapting the product or application, as well as extending the design of the product or application. Solution operation 338 may include, for example, monitoring the product or application and optimizing processes in the product or application.

Returning to FIG. 1, application 124 may represent any modeled software or other portion of business functionality or logic. A first instance of application 124 may represent a first application that is .NET-based, while a second instance of application 124 may be a similar hosted web-based solution. In yet another example, application 124 may be a modeled composite application with any number of portions that may be implemented as Enterprise Java Beans (EJBs), or the design-time components may have the ability to generate run-time embodiments into different platforms such as J2EE, ABAP (Advanced Business Application Programming) objects, or Microsoft's .NET. Further, while illustrated as internal to server 108, one or more processes associated with modeling environment 116 or application 124 may be stored, referenced, or executed remotely. For example, a portion of an application may be a web service that is remotely called, while another portion of the application may be an interface object bundled for processing at remote client 110. Moreover, modeling environment 116 or application 124 may each be a child or sub-module of other respective software modules or enterprise applications (not illustrated) without departing from the scope of this disclosure.

In particular, the application 124 can be implemented to realize a software application that implements enterprise application service interfaces using a number of elements associated with and defining its architectural design. The elements of the application's 124 architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

Generally, the architectural elements of the application 124 include the business object. A business object is a representation of a type of a uniquely identifiable business entity (an object instance) described by a structural model. Processes operate on business objects. A business object represents a specific view of some well-defined business content. A business object represents content, and instances of business objects include content, which a typical business user would expect and understand with little explanation. Whether an object as a type or an instance of an object is intended by the term “object” is generally clear from the context, so the distinction will be made explicitly only when necessary. Also, for convenience and brevity, an object instance may be described in this specification as being or including a real world event, activity, item, or the like; however, such description should be understood as stating that the object instance represents (i.e., contains data representing) the respective event, activity, item, or the like. Properly implemented, business objects are implemented free of redundancies.

Business objects can be further categorized as business process objects, master data objects, mass data run objects, dependent objects, and transformed objects. A master data object is an object that encapsulates master data (i.e., data that is valid for a period of time). A business process object, which is the kind of business object generally found in a process component, is an object that encapsulates transactional data (i.e., data representing a business entity or functionality that is valid for a point in time) and exposes services or interfaces that transform that data. A mass data run object is an application object that executes an algorithm for a particular mass data run. An instance of a mass data run object embodies or contains a particular set of selections and parameters. A mass data run object implements an algorithm that modifies, manages, and/or processes a large amount of data in multiple transactions, possibly, but not necessarily, with parallel processing. A dependent object is a business object used as a reuse part in another business object. A dependent object represents a concept that cannot stand by itself from a business point of view. Instances of dependent objects only occur in the context of a non-dependent business object. A transformed object is a transformation of multiple business objects for a well-defined purpose. It transforms the structure of multiple business objects into a common structure. A transformed object does not typically have its own persistency.

While the logical and operational flow of the various business objects within the environment 100 and the delivered applications may be hidden from a customer, it may nonetheless be desirable to allow customers (or other end users) some degree of access to the data embodied in these business objects and processed by these applications. Enterprises often use reporting and analytical tools to query and summarize data underlying their business in order to make important business decisions. Similarly, it can also be desirable to provide business customers with tools, in connection with environment 100, to allow queries and reports to be designed and produced from data processed and gathered through the applications of environment 100. Accordingly, in some instances of environment 100, reporting module 130 can be provided to provide analytics functionality to service-oriented application 124.

Specifically, the processor 120 can perform additional operations of server 108 including providing reporting, querying, and analytics support and functionality to customers through reporting module 130. Reporting module 130 can allow customers to query data from architecture elements including business objects, providing customers with the ability to generate reports pertaining to the services and customer-specific solutions provided through software environment 100. For example, the reporting module 130 may comprise an analytics composite application that helps enable users to gain credible, clear, and comprehensive business insights. This example application may normally leverage the business content and infrastructure to unify and integrate disparate data and processes from provider 101, third-party, and custom corporate applications, legacy systems, and externally syndicated information sources. The reporting module 130 provides information workers with the comprehensive views they need to take actions guided by strategy that are appropriate, timely, and in concert with their colleagues and the rest of their value network. Reporting module 130 may deliver insights across the extended value network, spanning multiple business functions, departments, and even organizations. Plus, the analytic functions are often designed for information workers so they may be easy to use, modify, and extend. It will be understood that while illustrated as part of server 108, the reporting module is most often utilized by business analysts or other end users, and therefore may be executing on client 110.

As such, the various components can utilize the BIVi object and its associated modeling layer to provide end users with the ability to easily create and request analytic queries in a more flexible and adaptable environment. A customer end-user module, such as the reporting module, can identify one or more business objects associated with a service-oriented enterprise software application, for example, in response to a query request. Upon identifying the business object, the end-user module can extract metadata relating to the identified business object. Using the business object and related metadata, the end user module can automatically generate a business information view object based on the business object and metadata. The generated business information view object can then be used, for example, to assist in processing the received query request.

Further, in some instances, the reporting module can receive a request for data associated with an enterprise software application, often in a reporting or analytic context. The application may be based on service-oriented architecture or some other enterprise software environment. The customer end user module, for example a reporting module, or a separate software module or computing device, can then identify a business information view object based on the received request for data. Queries can be embedded in the business information view object capable of completing queries related to business objects decoupled from the enterprise software application.

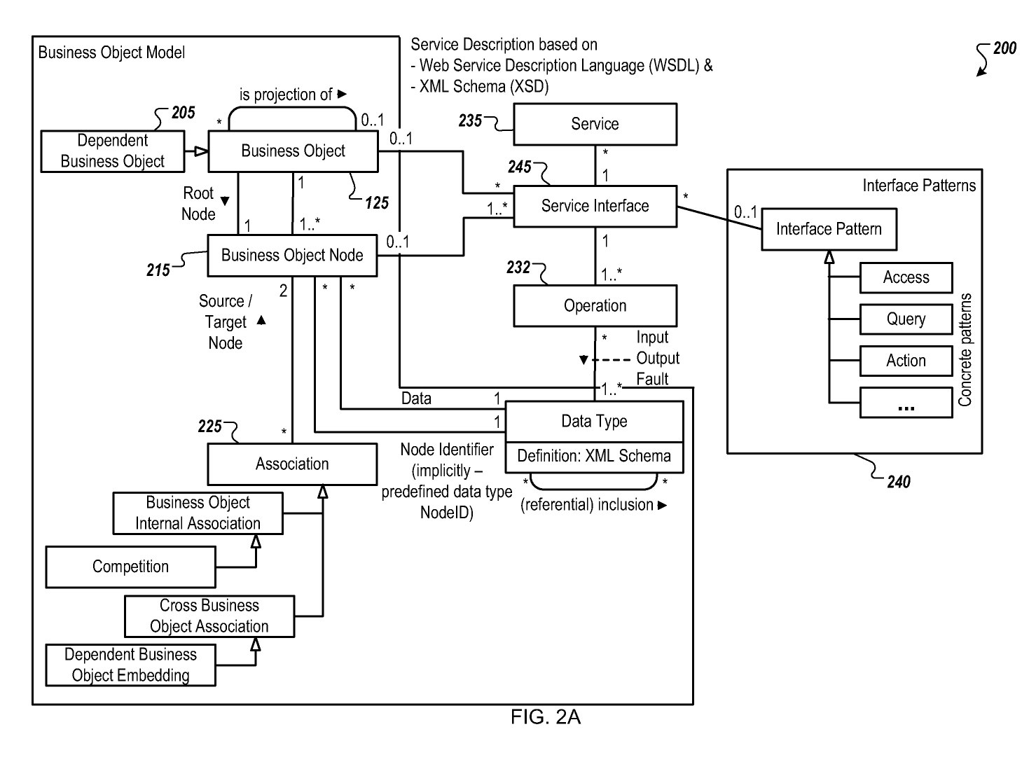

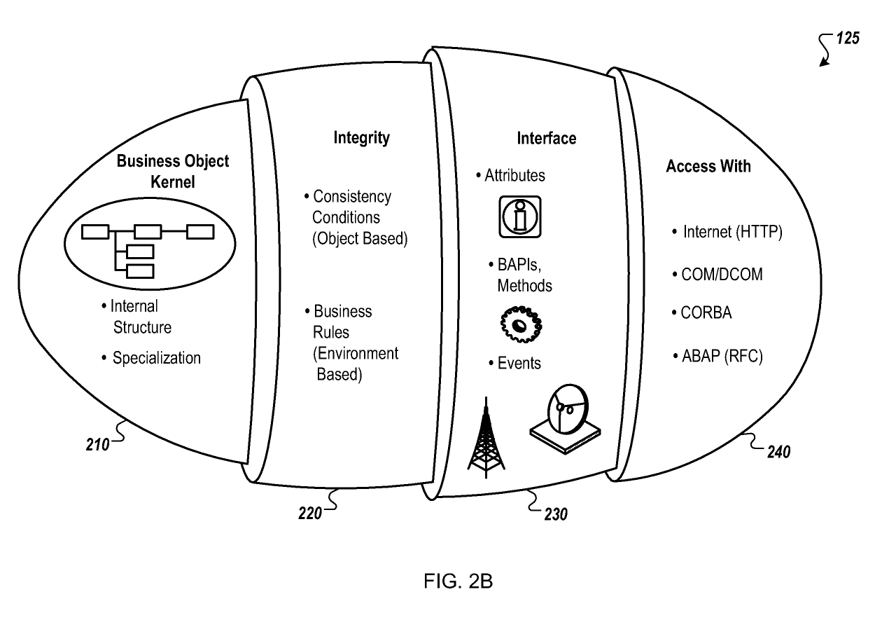

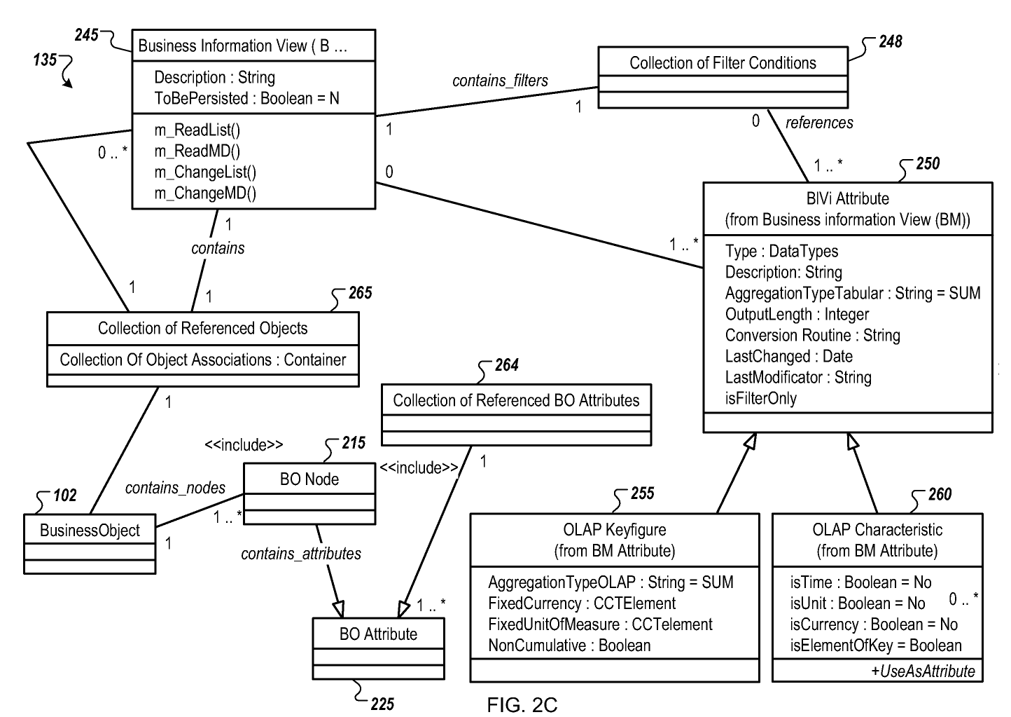

FIG. 2A illustrates an example business object model that includes various entities. The overall structure of the business object model ensures the consistency of the interfaces that are derived from the business object model. The derivation ensures that the same business-related subject matter or concept is represented and structured in the same way in all interfaces. The business object model defines the business-related concepts at a central location for a number of business transactions. In other words, it reflects the decisions made about modeling the business entities of the real world acting in business transactions across industries and business areas. The business object model, which serves as the basis for the process of generating consistent interfaces, includes the elements contained within the interfaces. These elements are arranged in a hierarchical structure within the business object model. In other words, the business object model is defined by the business objects and their relationship to each other (the overall net structure).

Entities are discrete business elements that are used during a business transaction. Entities are not to be confused with business entities or the components that interact to perform a transaction. Rather, “entities” are one of the layers of the business object model and the interfaces. Each business object 125 has a business object model conforming generally to model 200. The model 200 relates the business object 125 to its dependent business objects 205 as well as the business object node 215. A dependent business object 205 is not a stand-alone data object, but is instead a part of business object 125 capable of being used and re-used by other business objects interfacing with business object 125. A business object node 215 relates how a business object relates to other business objects, for example, associations 225 between the object 125 and another source or target business object. An association or a referential relationship type describes a relationship between two objects in which the dependent object refers to the less dependent object. For example, a person has a nationality, and thus, has a reference to its country of origin. There is an association between the country and the person. In some instances, business objects can be organized and interrelated in a hierarchical structure, in which case, the node 215 defines the relational placement of the business object 125 within the hierarchy. One or more data types are additionally associated with the business object 125 in the business object model 200. Data types are used to type object entities and interfaces with a structure. This typing can include business semantic. The business object 125 can be used within the context of a service having a service interface, and operation 232.

The relationships between the various entities have cardinalities. The cardinality between a first entity and a second entity identifies the number of second entities that could possibly exist for each first entity. Thus, a 1:c cardinality between entities A and X indicates that for each entity A, there is either one or zero entity X. A 1:1 cardinality between entities A and X indicates that for each entity A, there is exactly one entity X. A 1:n cardinality between entities A and X indicates that for each entity A, there are one or more entity Xs. A 1:cn cardinality between entities A and X indicates that for each entity A, there are any number of entity Xs (i.e., 0 through n Xs for each A).

FIG. 2B provides a graphical representation of a business object 125. As shown, an innermost layer or kernel 210 of the business object 125 may represent the business object's inherent data. For example, in a business object 125 representing an employee, inherent data may include, for example, an employee's name, age, status, position, address, etc. A second layer 220 may be considered the business object's logic. Thus, the layer 220 includes the rules for consistently embedding the business object in a system environment as well as constraints defining values and domains applicable to the business object 125. For example, one such constraint may limit sale of an item only to a customer with whom a company has a business relationship. A third layer 230 includes validation options for accessing the business object. For example, the third layer 230 defines the business object's interface that may be interfaced by other business objects or applications. A fourth layer 240 is the access layer that defines technologies that may externally access the business object.

Accordingly, the third layer 230 separates the inherent data of the first layer 210 and the technologies used to access the inherent data. As a result of the described structure, the business object 125 reveals only an interface that includes a set of clearly defined methods. Thus, applications may only access the business object via those defined methods. An application wanting access to the business object and the data associated therewith must include the information or data required to execute the clearly defined methods of the business object's interface. The clearly defined methods of the business object's interface represent the business object's behavior. That is, when the methods are executed, the methods may change the business object's data. Therefore, an application may utilize any business object by providing the required information or data without having any concern for the details related to the internal operation of the business object.

Returning to the architectural elements of the service-oriented application 124, process components are architectural elements that are software packages realizing a business process and generally exposing its functionality as services. Examples of process components are: due item processing, sales order processing, and purchase order processing. The functionality includes the ability to perform all or parts of particular kinds of business transactions. It acts as a reuse element in different integration scenarios and is often a modeling entity. A process component contains one or more semantically related business objects. Any business object belongs to no more than one process component.

Process components are mainly modeling entities to group business objects, bundle web service calls to message choreographies, and collect configuration settings. For configuration, process components are used to assign business process variant types for business configuration and for addressing of messages. As such, process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters, or some combination of them, serving as a signature. For convenience in supporting use of the operations supported by a system implementing elements of the design, such a system can optionally include a repository of service descriptions that includes a standards-based description of each of the supported service operations.

The architectural elements also optionally include the service interface, which may be referred to simply as an interface. An interface is a named group of operations. Each operation belongs to exactly one interface. An interface belongs to exactly one process component. A process component might implement multiple interfaces. In some implementations, an interface will have only inbound or outbound operations, but not a mixture of both. One interface can include both synchronous and asynchronous operations. All operations of the same type (either inbound or outbound) which belong to the same message choreography will preferably belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

An outbound process agent will generally perform some processing of the data of the business object instance whose change triggered the agent or caused the agent to be called. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components and, optionally, one or more business objects, that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interactions (i.e., interactions between process components involving their respective business objects, operations, interfaces, and messages) within other deployment units. Similarly, process components that interact with other process components or external systems only through messages, e.g., as sent and received by operations, can also be replaced as long as the replacement supports the operations of the original.

Interactions between process components that occur only within a deployment unit are not constrained to using service operations. These can be implemented in any convenient fashion.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are preferably assigned to their respective deployment unit.

FIG. 2C illustrates an example metamodel of a Business Information View (BIVi) object 135 for us in system 100. Generally, the BIVi object carries the complete query definition and references or stores information for relevant model entity creation, such as business semantics, object structures, associations, and cardinalities. With such BIVi objects, system 100 can more easily access and process data used in the query using access objects, basic query language (BQL) statements, Fast Search Index (FSI) views, or BSA according to the business data.

Specifically, the example meta model 135 includes the BIVi object 245 which can include string description data and persistence Boolean variables. Each BIVi object 245 can correspond to at least one business object 102 having a business object node 215 and business object attributes 225. Business object attributes can be additionally aggregated in a attribute container 264. Further, business objects 102, or other data objects, referenced by the BIVi object 245 can be stored in an object association container 265. A BIVi attribute container 250 can also be provided, storing BIVi attribute data such as applicable data types, object description, output data profile, as well as data recording when attributes of the object 245 were last changed or modified. BIVi attributes can be filtered for use by the BIVi object 245, a filter container 248 provided for storing available filters for use by the object 245. OLAP keyfigures 255 and characteristics 260 can further interface with the attribute container 250 to share attribute data between OLAP functionality and the BIVI object 245.

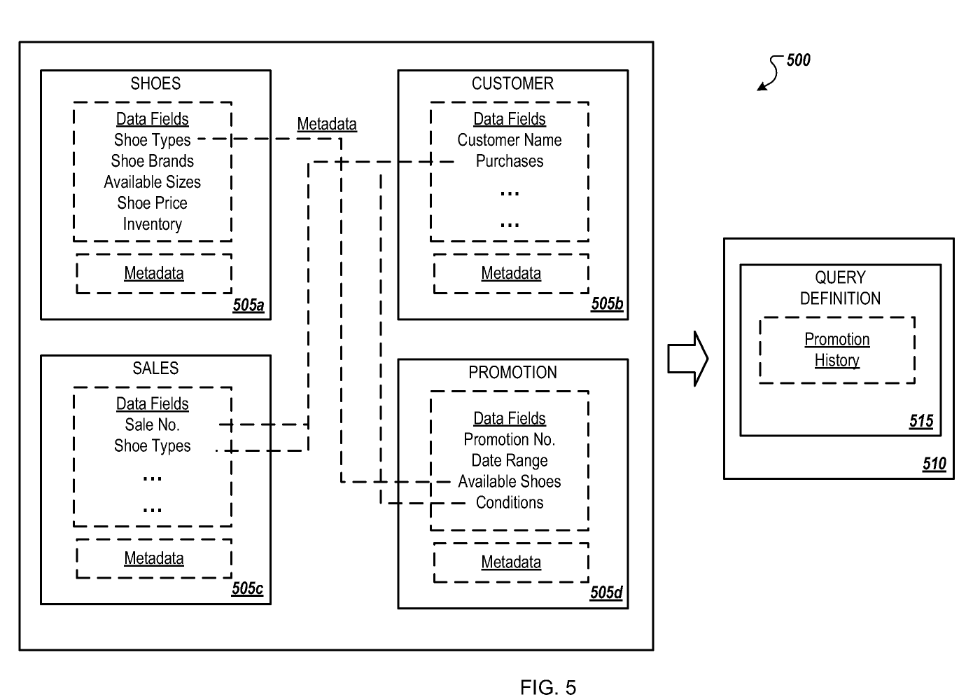

As an alternative to copying, staging, and transforming data structures from the environment to the reporting module—a process that is often resource intensive and potentially limiting on the extensibility of query building—an improved process can be employed to automatically generate a query definition in response to a customer query request using the BIVi objects. For example, FIG. 5 illustrates one method 500 for automatically generating a query definition from the data structure itself and related metadata. This method 500 may be described in terms of the software environment 100, but it should be understood that any other suitable system or environment may also be used to implement or perform the process. In short, this (or another similar) process can be accomplished by a computing device reading corresponding instructions—encoded on tangible machine readable media—for performing the described steps.

First, a query request is received at step 505 from a user relating to the functionality or data stored in one or more data structures, such as a business object. The request may be for a single query for data structure data or for a generalized, extensible query involving the relevant data structures. A reusable, extensible query can be implemented, for example, in connection with a report or analytics application aggregating, reporting, or performing calculations on multiple query results. The relevant data structures and modeling entities, referenced or embodied in application 124, to which the subject of the query request is directed, are then identified at step 510. The relevant data structures can be identified intelligently through instructions read by a computing device. Additionally, metadata relating to the data structure is extracted from environment at step 515. Metadata may be data internal to the data structure itself, defining relationships between data fields within the data structure, or other similar information. In other instances, where the data structure is affiliated with models, for example models employed by the modeling environment in the development of an application employing the data structure, metadata may be extracted defining relationships and operations connected to the model, the data structure, or even between data structures, by virtue of the affiliated model. Using the identified data structures and extracted metadata, a query definition is generated at step 520. As data structures' internal structure and related metadata can define data structure relationships in the form of operations, data fields, data types, and interactions between data types and fields, these relationships, together with relationships defined in connection with identified models and other metadata, can be used to define the relational structure of the query.

FIG. 6 illustrates a schematic representation of how an example query definition might be automatically generated according to the technique described in connection with FIG. 5. In an example where the enterprise software customer is an athletic shoe store, an enterprise software environment 600 may be implemented on behalf of the store by a third-party or other provider to assist the shoe store with sales, accounting and invoicing, inventory management, marketing, etc. Corresponding data objects 605 may be provided in connection with the software product 600, such as shoes 605a, customers 605b, sales 605c, and promotions 605d. In that these data objects represent a business concept or entity of the shoe store and its business, these data objects can be considered business objects. Each business object, 605a, 605b, 605c, 605d, in this example, has data associated with it. For example, the shoes data object 605a may include each of the shoe models sold, past and present, by the shoe store, along with the price of each pair of shoes, the brands, sizes available, sales or other promotions attached to each pair of shoes, the number of each pair of shoes in inventory, the date of the next shoe shipment, etc. Operations may also be included within the shoe business object, such as a method for calculating shoe price during a given sale or returning shoe inventory data. Internal metadata defines interrelations between the data and operation within an object. Additionally, the software 600 can include models defining interactions and relationships between objects 605. For example, certain promotions may be made for certain preferred customers of the shoe store. Models may be provided defining conditions for a customer (defined in the customers business object 605b) to qualify for a given promotion (outlined in the promotion business object 605d) attached to a given shoe (relating the customer business object 605b to the shoes business object 605a). Additional, external metadata can exists relating to these models, defining the relationships between business objects, operations, applications, and other data structures as established through modeling

Continuing with the shoe store example of FIG. 6, executives within the shoe store may desire to develop a report charting the effectiveness of a given promotional campaign in order to make a decision whether to continue or expand the campaign. Reporting tools 610 provided in connection with, and using the data of the software environment 600, may be used to develop such a report and the underlying data queries of system 600 data. The reporting tools, running in connection with system 600, could implement a technique, such as that described in connection with FIG. 5, to automatically generate the query definition related to the promotions query example above by using the internal and external metadata of business objects 605a, 605b, 605c, 605d defining the nature and type of the business object data and data fields, as well as relational attributes between the business objects and other software environment data structures and models, and between business object data fields within the same business object.

In this particular example, metadata could be extracted defining the relationship between a certain promotion data field within the promotion business object 605d and the applicable shoes listed in a shoe type data field of the shoes business object 605a to which these promotions apply. Various techniques may be employed using this relational data, such as a join between the shoes and promotions business object data. Data defining date ranges for limited-time promotions could also be provided, for example from a data field of the promotions business object 605d. Data from the customer object could include customer purchase histories. Additionally, customer purchase histories could be tied to data in the sales object. One query for the report could include a listing of purchases made during a given promotional period by customers who were eligible to take advantage of the promotion. Metadata and models between the relevant objects could define the relationships between each customer, their purchases, and promotions related to those purchases, allowing a query definition 615 to be automatically generated by the systems corresponding to the promotional history query request. This query 615 can be combined with other additional related or unrelated queries, also generated from the objects, models, and related metadata, to build a detailed report with comparisons, calculated results, and graphics, using the reporting module, to meet the reporting and analytics objective of the shoe store.

The preceding figures and accompanying description illustrate processes and implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving a query request for data associated with a service-oriented enterprise software application;
identify a business information view object based on the query request; and
query business objects decoupled from the enterprise software application using a query embodied in the business information view object.

2. The method of claim 1, wherein the business information view object comprises at least one business information view attribute.

3. The method of claim 1, wherein the business information view object comprises at least one filter.

4. The method of claim 1, wherein the business information view object comprises a container of referenced business objects.

5. The method of claim 1, wherein the business information view object is associated with a modeling layer, the modeling layer facilitating access to at least one of business semantic data, object structure, association between data objects, and data cardinality.

6. The method of claim 1, wherein the business object is queried in response to a received query request from an end user.

7. The method of claim 6, wherein the end user does not have access to the queried business object.

8. The method of claim 1, wherein the business information view object is capable of generating one or more of a business object access object, business query language statement, fast search index view, or BSA.

9. The method of claim 1, wherein the business object is a data object for use in an object-oriented computing environment and contains data representing defined business content.

10. A computer-implemented method comprising:
identifying a business object associated with a service-oriented enterprise software application;
extracting metadata relating to identified business object; and
automatically generating a business information view object based on the business object and extracted metadata.

11. The method of claim 10 further comprising automatically generating at least one other object for use by the business information view object.

12. The method of claim 11, wherein the at least one other object is one of a business object access object, business query language statement, fast search index view, or BSA.

13. The method of claim 10, wherein identifying a business object associated with a service-oriented enterprise software application is in response to a query request by an end user.

14. The method of claim 13, wherein the end user is prohibited from accessing to the identified business object.

15. A computer program product for performing queries of business objects decoupled from a service-oriented enterprise software application, the computer program product comprising computer readable instructions embodied on tangible media and operable when executed to:
receive a query request for data associated with the enterprise software application;
identify a business information view object based on the query request; and
query at least one business object, decoupled from the enterprise software application, using a query embodied in the business information view object.

16. The computer program product of claim 15, wherein the computer readable instructions are further operable when executed to:
extract metadata relating to the at least one business object; and
automatically generate the business information view object based on the at least one business object and extracted metadata.

17. The computer program product of claim 15, wherein the business information view object is associated with a modeling layer, the modeling layer facilitating access to at least one of business semantic data, object structure, association between data objects, and data cardinality.

18. The computer program product of claim 15, wherein the query request is generated by an end user and the end user does not have access to the queried business object.

19. The computer program product of claim 15, wherein the business information view object is capable of generating one or more of a business object access object, business query language statement, fast search index view, or BSA.

20. The computer program product of claim 15, wherein the business object is a data object for use in an object-oriented computing environment and contains data representing defined business content.
